(19) United States
(12) Patent Application Publication
(10) Pub. No.: US 2009/0055150 A1
(43) Pub. Date: Feb. 26, 2009

(54) SCALABLE, COMPUTATIONALLY EFFICIENT AND RAPID SIMULATION SUITED TO DECISION SUPPORT, ANALYSIS AND PLANNING

(75) Inventors: Stephen D. PRIOR, Arlington, VA (US); Akhileswar Ganesh VAIDYANATHAN, Wilmington, DE (US); Eli T. FAULKNER, Wilmington, DE (US); Michael KOLB, Newark, DE (US)

Correspondence Address: GOMEZ INTERNATIONAL PATENT OFFICE, LLC, 1501 N. RODNEY STREET, SUITE 101, WILMINGTON, DE, 19806, US

(73) Assignee: QUANTUM LEAP RESEARCH, INC., Claymont, DE (US)

(21) Appl. No.: 12/198,036

(22) Filed: Aug. 25, 2008

Related U.S. Application Data
(60) Provisional application No. 60/968,044, filed on Aug. 25, 2007.

(51) Int. Cl. G06G 7/50; G06G 7/48

(52) U.S. Cl. 703/11; 703/6

(57) ABSTRACT

The present invention provides a means for performing scalable, computationally efficient and rapid simulations of complex or complex adaptive systems realized through the dynamic interaction of multiple modeling components to generate outputs suited to decision support, analysis and planning. In the context of disease modeling, these outputs can be used for analyzing the impact of disease and the potential value of the use of pharmaceutical and non-pharmaceutical interventions.

### CROSS REFERENCE TO RELATED APPLICATION

The present application claims priority from U.S. Provisional Application Ser. No. 60/968,044, filed on 25 Aug. 2007.

### STATEMENT REGARDING FEDERALLY SPONSORED RESEARCH OR DEVELOPMENT

Portions of the present invention were developed with funding from the Office of Naval Research under contracts N00014-02-C-0320, N00014-05-C-0541, N00014-07-C-0014 and N00014-07-C-0528.

### BACKGROUND OF THE INVENTION

The present invention describes a near real-time decision support/course-of-action analysis tool that provides a realistic modeling environment that allows operators to experiment with disease parameters and intervention/containment strategies and compare/contrast results.

The invention provides a means for performing scalable and computationally efficient and rapid simulation of complex or complex adaptive systems realized through the dynamic interaction of multiple modeling components to generate outputs suited to decision support, analysis and planning. In the context of disease modeling, these outputs can be used for analyzing the impact of disease and the potential value of the use of pharmaceutical and non-pharmaceutical interventions.

In the context of disease modeling, the goal of the invention is to utilize recent advances in computer technology and agent-based models to construct computational models of the effects that disease and related intervention and treatment procedures have on populations. Specific emphasis has been placed on developing prognostic modeling capabilities that are easy to use. The invention enables its users to assess the benefit of specific health interventions (pharmaceutical and non-pharmaceutical), determine resource requirements for treatment of personnel, and provide analysis for the potential impact of the disease. The invention enables its users to dynamically invoke and measure the impact of intervention strategies at any point during a simulation. Simulations can be replayed for retrospective analysis using different interventional strategies. This capability, unique to the invention, provides decision support capability by modeling the interventions (including combinations of interventions) and providing outputs in the form of prognoses that will enable the user to determine his/her best course of action. The present invention also has a capability that enables multiple rapid tests to be performed using singular or multiple interventions and treatments and thus enables the user to optimize his/her guidance and actions for effective disease management.

The core framework for the disease modeling component of the invention is the linking of classic differential equations to an agent-based model (ABM) or ABM simulator. The advantage of the ABM approach is that the complexity of the system being modeled is realized by the dynamic interaction of the components of the system rather than modeling the complexity explicitly. This results in simpler, modular models that are easier to construct and often more representative of the real system. Agents interact by moving about (or being moved) in a simulated world that represents travel and mixing patterns. Using an ABM approach for the invention has enabled the development of a model that has very fast run-time (seconds/minutes) on typical PC platforms.

The present invention is a scalable (global to local) tool that provides a rapid run-time environment to generate outputs suited to decision support and analysis and planning. The models can be configured for a variety of environments for example, to support military use in the battlespace where disease can reduce operational capability. The invention can further be configured to model naturally-occurring and man-made (Biological warfare—BW) agents. The tool can be run on a single computer (laptop or desktop) or through the use of a web-based interface. The accessibility of the simulations in the invention, its run-time and the breadth of diseases covered make it an ideal commander's decision support tool on which options for decisions about mission capability and mitigation strategies can be explored in near real-time.

### Discussion of Prior Art

The present invention provides a means for performing scalable, computationally efficient and rapid simulations of complex or complex adaptive systems realized through the dynamic interaction of multiple modeling components to generate outputs suited to decision support, analysis and planning. In the context of disease modeling, these outputs can be used for analyzing the impact of disease and the potential value of the use of pharmaceutical and non-pharmaceutical interventions. The invention is a near real-time decision support/course-of-action analysis tool that provides a realistic modeling environment that allows operators to experiment with disease parameters and intervention/containment strategies and compare/contrast results.

For the application to disease modeling the invention described utilizes models and model components that are previously described but the invention contemplates their use in a novel and inventive way to generate outputs suited to decision support, analysis and planning.

The use of mathematical modeling to discover the likely outcome of a disease outbreak has been described by many authors for a wide range of diseases spread by many different routes—See Reference: N. T. Bailey, The Mathematical Theory of Infectious Diseases (2nd edition), Charles Griffin and Co. Ltd (1975)).

The use of mathematical modeling of interventions—pharmaceutical and non-pharmaceutical—and their impact on disease spread has also been described by many authors.—See Reference: Sattenspiel L, Dietz K: A Structured Epidemic Model Incorporating Geographic-Mobility among Regions. Mathematical Biosciences 1995, 128(1-2):71-91.

In recent years accurate mathematical models of disease spread and the mitigation of disease spread through the application of pharmaceutical and non-pharmaceutical strategies have been published. The current state of the art was recently reviewed by Barthelemy et al (Reference: Barthelemy, M., et al.: Dynamical patterns of epidemic outbreaks in complex heterogenous networks. Journal of Theoretical Biology (2005) 235:275-288). Each of these models can provide inputs to the invention described but none contemplate the development of a scalable and computationally efficient simulation of complex, adaptive systems realized through the dynamic interaction of multiple modeling components to generate outputs suited to decision support, analysis and planning.

With the recent spread of SARS (Severe Acute Respiratory Syndrome) and the emergent threat of a new episode of Pandemic Influenza a number of authors have published models addressing these two diseases. These recent publications utilize some of the key modeling parameters that are described as examples for the invention but none describe the combination of the models to generate the simulation capability described as the invention. Some of the key publications include:
Hufnagel, L. et al: Forecast and control of epidemics in a globalized world. Proceedings of the National Academies of Science (2004) 101(42): 15124-15129.
Grais, R F. et al: Modeling the Spread of Annual Influenza Epidemics in the U.S.: The Potential Role of Air Travel. Health Care Management Science (2004) 7: 127-134.
Brownstein, J S. et al: Empirical Evidence for the Effect of Airline Travel on Inter-Regional Influenza Spread in the United States, PLoS Medicine (2006) 3(10)
Camitz, M. and Liljeros, F.: The effect of travel restrictions on the spread of a moderately contagious disease. BMC Medicine (2006) 4(32): 1 -10.
Colizza, V. et al: Modeling the Worldwide Spread of Pandemic Influenza:

Baseline Case and Containment Interventions. PLoS Medicine (2006) 4(1): e13 0095-0110.
Ferguson et al: Planning for smallpox outbreaks. Nature (2003) 425: 681-685.
Larson, R C. Simple Models of Influenza Progression Within a Heterogenous Population. Operations Research (2007) 55(3): 399-412.

Each of these models can provide inputs to the invention described but none contemplate the development of a scalable and computationally efficient simulation of complex, adaptive systems realized through the dynamic interaction of multiple modeling components to generate outputs suited to decision support, analysis and planning. Grais et al, Colizza et al, Camitz et al and Brownstein et al describe the role of the airline travel and transportation networks in the prediction and predictability of global epidemics but none of the cited models teach the recording of the state of all modeling entities at each time point during a simulation in the form of a database or other suitable dataset, which capability when combined with the provision of a user interface further enables a simulation to be modified at a specific time point to generate a new simulation under user selected conditions. Furthermore, none of the cited publications teach the integration of analytical tools for use with the simulator to provide outputs that can be used for decision support, analysis and planning.

The use of multiple model components to simulate a biological system has been previously described. US Patent Publication 20040088116 submitted by Khalil et al describes “Methods and systems for creating and using comprehensive and data-driven simulations of biological systems for pharmacological and industrial applications.” Khalil et al describe a method of creating a scalable simulation of a biological system, including the integration of diverse data sources, where integrating diverse data types includes utilizing data mining tools. While Khalil et al ‘relates to the graphic and mathematical modeling of biological systems and subsystems’ the invention is focused on ‘creation of simulations for pharmacological and industrial applications.’

With respect to present invention Khalil et al do not support a method of creating a scalable, computationally efficient and rapid simulation of complex or complex adaptive systems realized through the dynamic interaction of multiple modeling components to generate outputs suited to decision support, analysis and planning, comprising:
The specification and modeling of spatial networks that describe the relationship between locations or nodes in the component models and the multi-model simulation.
The specification and modeling of social networks that describe the relationship between model entities at, or interacting with, a location or node, or locations or nodes in the component models and the multi-model simulation.
The specification of at least one state based model where entities at a location or node can undergo state transitions that can further be modified based on the dynamic application of interventions that modify state transitions.

Furthermore, Khalil et al do not teach the recording of the state of all modeling entities at each time point during a simulation in the form of a database or other suitable dataset, which capability when combined with the provision of a user interface further enables a simulation to be modified at a specific time point to generate a new simulation under user selected conditions. Khalil et al do not teach the integration of analytical tools for use with the simulator to provide outputs that can be used for decision support, analysis and planning.

Ford et al (Reference: Ford D A., et al: An extensible spatial and temporal epidemiological modeling system, International Journal of Health Geographics (2006) 5(4)). describe “An extensible spatial and temporal epidemiological modeling system” (STEM). They do not teach the recording of the state of all modeling entities at each time point during a simulation in the form of a database or other suitable dataset, which capability when combined with the provision of a user interface further enables a simulation to be modified at a specific time point to generate a new simulation under user selected conditions. Further, they do not teach the integration of analytical tools for use with the simulator to provide outputs that can be used for decision support, analysis and planning.

Finally, Eubank et al (Reference: Stephen Eubank, Hasan Guclu, V. S. Anil Kumar, Madhav V. Marathe, Aravind Srinivasan, Zoltan Toroczkai, Nan Wang, Modelling Disease Outbreaks in Realistic Urban Social Networks, Nature (2004) 429: 180-184) and Emrich et al (Reference: Stefan Emrich, Sergej Suslov, Florian Judex. EUROSIM 2007, September 9-13 2007, Ljubljana, Slovenia) describe agent based methods for modeling disease outbreaks. Emrich et al demonstrate qualitative agreement between the behavior of agent based models with other disease modeling methods such as those based on solving Ordinary Differential Equations. However as Emrich et al observe “Although major improvements in terms of runtime have been achieved from AnyLogic 5.5 to version 6.0 a weakness still remains when simulating huge systems.” Neither Eubank et al nor Emrich et al teach the use of hybrid models that use multiple diverse modeling paradigms concurrently as described in the present invention to balance modeling fidelity with computation time. Furthermore, neither Eubank et al nor Emrich et al teach the capability of enabling a simulation to be modified at a specific point to generate a new simulation as described in the present invention.

The present invention overcomes the limitations of the prior art and provides a novel means for performing scalable and computationally efficient simulation of complex or complex adaptive systems realized through the dynamic interaction of multiple modeling components to generate outputs suited to decision support, analysis and planning.

### SUMMARY OF THE INVENTION

The present invention provides a method of creating a scalable, computationally efficient and rapid simulation of complex or complex adaptive systems realized through the dynamic interaction of multiple models or modeling components for generating outputs suited to decision support, analysis and planning, comprising:
(a) specifying and modeling a plurality of spatial networks that describe the relationship between a plurality of locations or nodes in a plurality of component models and a multi-model simulation;
(b) specifying and modeling a plurality of social networks that describe at least one relationship between model entities at, or interacting with at least one location or at least one node in the component models and the multi-model simulation;
(c) specifying at least one state based model where entities at a location or node can undergo state transitions that can further be modified based on the dynamic application of interventions that modify state transitions;
(d) using at least one agent based simulator for integrating the individual modeling components where the individual modeling components are designated as agents;
(e) capturing dynamically-updated storage of incremental changes in the simulation in the form of a database or other suitable dataset;
(f) linking the agent based simulation with at least one visualization layer and using the linkage for providing visualization of one or more of the simulations;
(g) providing a user interface for supporting users configuring the simulation and for enabling a simulation to be modified at a specific point for generating a new simulation; and
(h) integrating analytical tools for using the simulator for providing outputs for supporting decision support, subsequent analysis and planning.

The invention further provides a hybrid simulation engine for modeling global disease spread comprising a computer system, having one or more processors or virtual machines, each processor comprising at least one core, the system comprising one or more memory units, one or more input devices and one or more output devices, optionally a network, and optionally shared memory supporting communication among the processors for rapid simulation of complex or complex adaptive systems realized through the dynamic interaction of multiple models or modeling components for generating outputs suited to decision support, analysis and planning comprising,
(a) means for specifying and modeling a plurality of spatial networks that describe the relationship between a plurality of locations or nodes in a plurality of component models and a multi-model simulation;
(b) means for specifying and modeling a plurality of social networks that describe at least one relationship between model entities at, or interacting with at least one location or at least one node in the component models and the multi-model simulation;
(c) means for specifying at least one state based model where entities at a location or node can undergo state transitions that can further be modified based on the dynamic application of interventions that modify state transitions;
(d) means for using at least one agent based simulator for integrating the individual modeling components wherein the individual modeling components are designed as agents;
(e) means for capturing dynamically-updated storage of incremental changes in the simulation in the form of a database or other suitable dataset;
(f) means for linking the agent based simulation with at least one visualization layer and using the linkage for providing visualization of one or more of the simulations;
(g) means for providing a user interface for supporting users configuring the simulation and for enabling a simulation to be modified at a specific point for generating a new simulation; and
(h) means for integrating analytical tools for using the simulator for providing outputs for supporting decision support, subsequent analysis and planning.

### BRIEF DESCRIPTION OF THE DRAWINGS

FIG. 1 illustrates the present invention relative to other disease modeling approaches.

FIG. 2 illustrates the present invention in the context of the full spectrum of disease models.

FIG. 3 illustrates the present invention showing a PACOM AOR simulation.

FIG. 4 shows time slider elements of the present invention.

FIG. 5 presents an intervention window within the configuration window of the present invention.

FIG. 6 shows the analysis window of the present invention.

FIG. 7 illustrates the present invention showing a PACOM/Hawaii simulation.

FIG. 8 illustrates the present invention showing a PACOM/Hawaii AOR simulation.

FIG. 9 presents the framework for the SDDT example of the present invention.

FIG. 10 presents the SDDT application of the present invention.

FIG. 11 illustrates secondary effects of disease spread with the compartment view of the present invention.

FIG. 12 illustrates selection of the shop-red-enlisted group for seeding an infection.

FIG. 13 illustrates using the shipboard analysis tool of the present invention.

### GLOSSARY OF TERMS

Computationally efficient: Use of a computer system, having one or more processors or virtual machines, each processor comprising at least one core, the system comprising one or more memory units, one or more input devices and one or more output devices, optionally a network, and optionally shared memory supporting communication among the processors to produce the desired effects without waste.

Rapid simulation: Run-times for the simulation, from initiation to completion, in periods ranging from seconds to less than ten minutes per simulation.

Complex system: A complex system is a system composed of interconnected parts that as a whole exhibit one or more properties (behavior among the possible properties) not obvious from the properties of the individual parts. Examples of complex systems include most biological materials—organisms, cells, subcellular components—environment, human economies, climate, energy or telecommunication infrastructures.

Complex adaptive system (CAS): Complex adaptive systems are special cases of complex systems. They are complex in that they are diverse and made up of multiple interconnected elements and adaptive in that they have the capacity to change and learn from experience.
A Complex Adaptive System (CAS) is a dynamic network of many agents (which may represent cells, species, individuals, firms, nations) acting in parallel, constantly acting and reacting to what the other agents are doing.

The control of a CAS tends to be highly dispersed and decentralized. If there is to be any coherent behavior in the system, it has to arise from competition and cooperation among the agents themselves. The overall behavior of the system is the result of a huge number of decisions made every moment by many individual agents (Complexity: The Emerging Science at the Edge of Order and Chaos by M. Mitchell Waldrop).
A CAS behaves/evolves according to three key principles: order is emergent as opposed to predetermined, the system's history is irreversible, and the system's future is often unpredictable. The basic building blocks of the CAS are agents. Agents scan their environment and develop schema representing interpretive and action rules. These schema are subject to change and evolution (Dooley, K. Accessed at http://www.eas.asu.edu/˜kdooley/casopdef.html (Accessed: Aug. 21, 2008)).

Examples of complex adaptive systems include the markets, financial markets, online markets, advertising, consumer behavior, opinion modeling, belief modeling, political modeling, and social norms and any human social group-based endeavor in a cultural and social system such as political parties or communities.

Modeling components: Constituent parts of the model that can act on, or influence the entities in the simulation.

Location: Identifiable site within the simulation marked by a distinguishing feature. Examples include: Geographical site (Country, City, military base), Facility or room or rooms within a facility, Compartments or other defined area on a vessel, ship, vehicle or aircraft, population of individuals, organ, or population of cells within a biological system.

Node: Identifiable site within the simulation, not previously identified as a location, which represents a point of intersection between the component models and the simulation or between component models. Examples include: individuals or sub-groups in a population, resources that support interventions (stockpiles of material), cells or subcellular components in a biological system.

Entity: An identifiable component of the model or simulation that has separate and discrete existence. Entities are objects that are used in the model or simulation to interact with one another or the simulation environment to modify the state of one or more of the other entities in the simulation or to change the environment to influence the behavior or reaction of one or more entities in the simulation. For example for biological systems the entities include but are not limited to: molecular species, cell structures, organelles, cells, tissue, organs, physiological structures, organisms, demes, populations of organisms, ecosystems, and biospheres, the genome, the proteome, the transcriptome, the metabolome, the interactome, molecules within cells, molecules among cells, organelles, cells within tissues, cells within organs, signaling, signal cascades, messaging, transduction, propagation of information among aggregates of cells, neuron populations, cell fate, programmed cell death, epigenetics, flora and other commensal organisms, symbiotic organisms, parasitic organisms, bacteria, fungi, archaea, viruses, prions, social organisms, species, members of the animal kingdom, and members of the plant kingdom.

State transitions: The entities are described as having an initial state in the simulation (or model). State transitions are the time dependent alterations to the state of the entities that occur during the simulation or modeling that enable the system to change according to pre-defined rules or algorithms. Examples include the state transitions in disease models between the states that individuals or populations may exhibit before and during exposure to a pathogen; for example, susceptible, exposed, infected and recovered. In this example the probability of a state transition and the rate of state transition between the defined states are described by differential equations.

Interventions: An entity that modifies the outcome or course of state transitions in the model or simulation so as to change the probability or rate of state transition. Examples include the application of pharmaceutical or non-pharmaceutical interventions to a simulation of a disease. The intervention can modify the transitions between states (for example by altering the susceptibility (initial state) of entities in the simulation (vaccines work in this way)) or by altering the transition between states by modifying the probability and/or rate of a state transition occurring (for example by treating an infection (antimicrobials work in this way)).

Disease phenomena: A condition of the living animal or plant body or of one of its parts that impairs normal functioning and is typically manifested by distinguishing signs and symptoms. Disease phenomena examples include: communicable diseases, infectious diseases, single species diseases, multiple species diseases, disease vectors, epidemics, pandemics, environmental diseases, non-communicable diseases, disease immunity, inoculation, herd immunity, maternal immunity, epigenetic-related diseases, and prion diseases.

### DETAILED DESCRIPTION OF THE INVENTION

The present invention provides a means for performing scalable, computationally efficient and rapid simulations of complex, adaptive systems realized through the dynamic interaction of multiple modeling components to generate outputs suited to decision support, analysis and planning. In the context of disease modeling these outputs can be used for analyzing the impact of disease and the potential value of the use of pharmaceutical and non-pharmaceutical interventions on population groups.

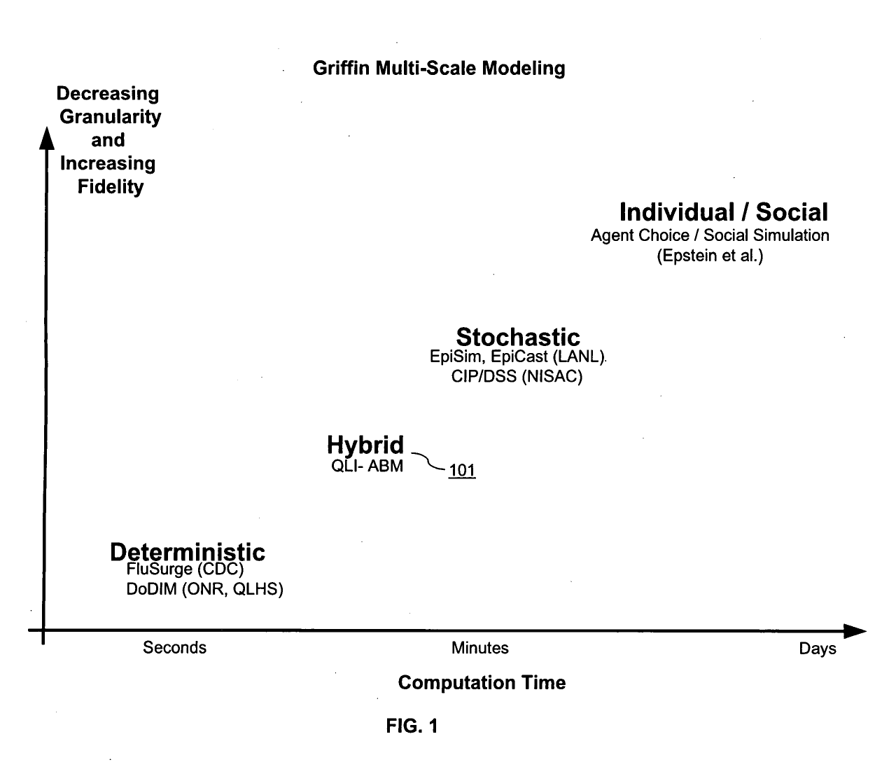

An important design objective of the present invention is to utilize recent advances in computer technology and agent-based models (ABM) to construct scalable, computationally efficient models that measure the impact of disease and related intervention and treatment procedures upon populations. FIG. 1 illustrates the positioning of the present invention 101 versus other disease modeling approaches in terms of both modeling fidelity and computation time.

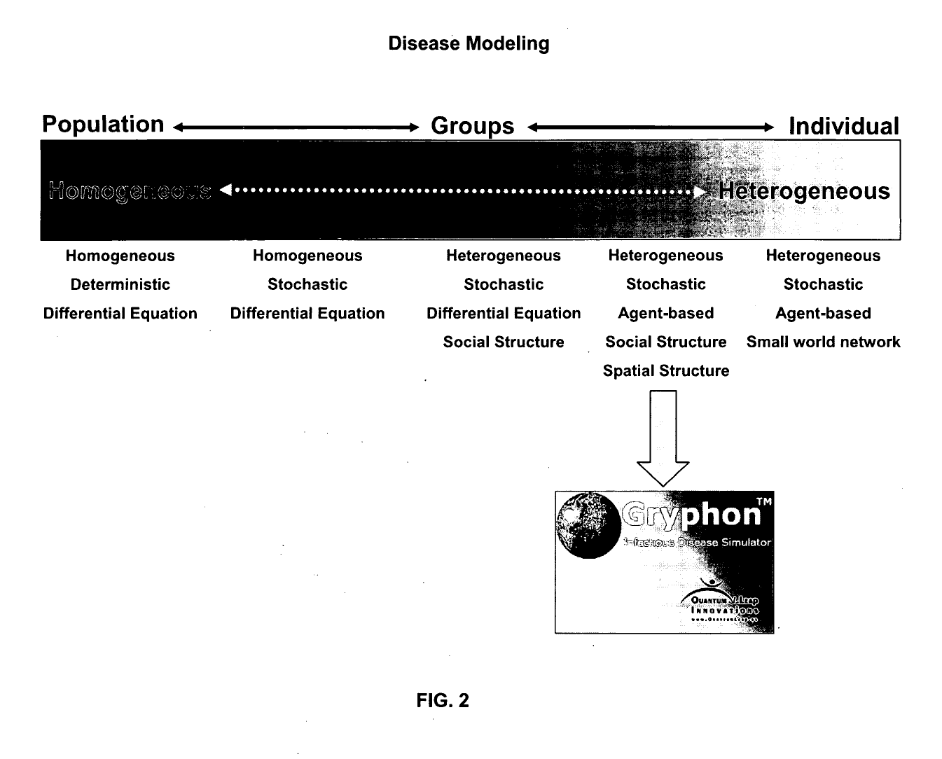

FIG. 2 provides a more detailed view of the position of the invention—currently called the Gryphon simulator—in the context of the full spectrum of disease models. The invention does not represent a novel approach to disease modeling per se, rather it uses a specific approach to disease modeling to support scalable, computationally efficient and rapid simulations of complex, adaptive systems realized through the dynamic interaction of multiple modeling components to generate outputs suited to decision support, analysis and planning.

The “hybrid” capability that is the subject of the present invention uses multiple modeling methods to drive a balance between modeling fidelity and computation time that are suited to decision support, analysis and planning. Agent based models that attempt to model at the level of individuals through the creation of ‘small world’ networks are potentially able to model disease spread with high fidelity at the expense of significant computation time, measured typically in hours and days even with required use of high performance computers. At the opposite end of the spectrum, purely deterministic methods such as FluSurge (available from CDC, Atlanta, Ga.) make simplifying assumptions around the homogeneity of population groups that sacrifice disease modeling fidelity for computational speed. The hybrid system embodied by the present invention combines deterministic local models with stochastic, agent based non-local models to generate populations with high fidelity and computation time on the order of minutes using standard PC technology. The present invention further uses one or more agent based simulators to integrate the individual modeling components to provide the final modeling environment.

In addition to the hybrid methods employed to drive disease spread in a computationally efficient manner, specific emphasis has been placed in the present invention on developing prognostic modeling capabilities that enable users to assess the benefit of specific health interventions or treatments, determine resource requirements for treatment of populations and/or personnel, and generate information about the potential impact of the disease and the effectiveness of the use of interventions. The approach described in the invention also supports the analysis of the timing of the application of the interventions and provides a method for investigating the combination of interventions; including combinations of pharmaceutical and non-pharmaceutical interventions.

The present invention enables users to dynamically invoke and measure the impact of intervention strategies at any point during a simulation. Simulations can be replayed for retrospective analysis using different interventional strategies. This capability, unique to the present invention, provides decision support capability by modeling the interventions (including combinations of interventions) and providing outputs in the form of prognoses that will enable the user to determine the best course of action. The present invention will permit multiple rapid tests to be performed using singular or multiple interventions and treatments and thus allow the user to optimize guidance and actions for effective disease management.

An important characteristic of the present invention lies in defining the system to be modeled around three broad foundational themes:
The specification and modeling of spatial networks that describe the relationship between locations or nodes in the component models and the multi-model simulation.
The specification and modeling of social networks that describe the relationship between model entities at, or interacting with, a location or node, or locations or nodes in the component models and the multi-model simulation.
The specification of at least one state based model where entities at a location or node can undergo state transitions that can further be modified based on the dynamic application of interventions that modify state transitions.

The present invention system provides a flexible modeling environment for the user to configure both spatial and social networks at multiple levels of fidelity/resolution, in addition to specifying the disease models. The core framework for the disease modeling component of the present invention is the linking of standard differential equations for disease modeling (e.g. SIR, SEIR, and other well known epidemiological models—Reference: N. T. Bailey, The mathematical Theory of Infectious Diseases (2nd edition), Charles Griffin and co. Ltd (1975)) to an agent based simulation engine to enable the non-local or global modeling of the stochastic spread of disease. The result is a unique hybrid simulation engine, capable of modeling global disease spread on the order of minutes using a standard PC platform.

The simulation engine records the state of all modeling entities at each time point during the simulation in the form of a database or other suitable dataset. The provision of a user interface further enables a simulation to be modified at a specific time point to generate a new simulation under user selected conditions. These conditions could, for example, include the application of one or more interventional strategies to simulate the impact of the selected interventions on subsequent disease spread. The capability of simulating disease spread under user defined conditions at any point in the simulation to generate new simulations from that point hence represents a key inventive step embodied in the present invention. Simulating the impact of interventions on both subsequent disease spread as well as subsequent resource utilization enables the present invention to be used as an effective operational planning tool in the face of disease outbreaks to provide guidance on the most suitable courses of action to pursue.

The system proposed in the present invention further links the agent based simulation with one or more visualization layers that can provide visualization of one or more of the simulations. The visualization layers can enable visualization of the area of interest (AOI) being modeled, and also allow the user to interact with the underlying data base to generate new simulations. The present invention further allows for the possibility of performing multiple simulations under the same operational conditions, with each simulation run being driven by a different statistical sampling of the underlying disease parameters. This capability permits the measurement of a confidence range to the predictions developed by the simulation engine.

The present invention further provides for the obtaining of static or dynamic external data or parameters relating to at least one modeling component within the simulator, and to use such external data or parameters as empirical evidence relating to at least one modeling component within the simulator. The present invention further provides for the learning of one or more variables or relationships of the representation parameters of at least one modeling component from the empirical evidence, and to learn at least one correspondence between a plurality of modeling components from the empirical evidence.

The following examples have been included to further exemplify the present invention and illustrate technical character and practical application. The examples are in no way meant to be limiting.

### EXAMPLES

### Example 1

### United States Pacific Command (PACOM)

The present invention has been applied to model the spread of pandemic influenza at multiple levels of resolution in the Area of Operational Responsibility (AOR) for the United States Pacific Command (PACOM). This AOR includes Southeast Asia, Australia, and Alaska and Hawaii. This example demonstrates the capability of the present invention to model across different scales of both spatial and social networks in a flexible fashion, to model disease spread and the impact of pharmaceutical and non-pharmaceutical interventions, suited to decision support, analysis and planning; and to do all of the above in a computationally efficient manner in a PC-based computing environment. The run time for the simulation where the multiple models are linked in the example—even at the most complex level described below—is less than 40 seconds.

The present invention and example described below can be usefully described as:
Spatial Network—Describes the relationship between locations in the simulation.
Social Network—Describes the relationship between agents at a location.
Disease Model—Model of disease behavior in terms of state transitions, also includes modifications of state transitions based on applying interventions.
Agent-based Simulator—Simulation environment for linkage of components noted above.
Visualization Layer—UI to provide visualization of the simulation.
Analytical and Export Capability—Analytical tools for use with the simulator and capability to export data to external analytical packages.

In this example the components noted above are further detailed as:

| Component | Details |
|---|---|
| Spatial | Defined by the AOR (Area Of Responsibility) of US Pacific |
| Network | Command (US Department of Defense). Spatial networks are |
| | modeled from published national and international travel data. |
| Social | Defined by the AOR (Area Of Responsibility) of US Pacific |
| Network | Command (US Department of Defense (DoD)). Social networks are |
| | modeled from published data on national populations and sub- |
| | populations and data from the DoD on populations and locations of |
| | military operations in the PACOM AOR. |
| Disease Model | Pandemic Influenza: Disease parameters from published source |
| | (Centers for Disease Control, Atlanta, GA) |
| ABM | MASON: Publicly available from George Mason University, Fairfax, |
| Simulator | VA |
| Visualization | OpenMap: Publicly available from BBN Technologies, Cambridge, |
| Layer | MA |
| Analytical/ | Developed by Quantum Leap Innovations, Inc. Newark, DE |
| Export | |

The example provides for simulating the AOR at three different levels of modeling complexity:

Level 1. PACOM AOR—The PACOM AOR simulations model disease incidence and disease spread at the country level based on known patterns of international travel. Each country is considered as a single, aggregated entity. Civilian populations and airline travel to various cities in each country are combined to model the entire country as a single entity. Mixing among civilian populations is determined by travel patterns based on airline flight statistics.

Level 2. Detailed PACOM AOR—The Detailed PACOM AOR simulations model the spread of disease in both civilian and military populations using inter- and intra-group networks. Populations are split into two groups, civilian and military. Each country is further modeled as an entity consisting of the most populous cities as well as PACOM bases. Civilians from each city mix with one another based on the distance between the two cities, the total population in each city and travel patterns between cities based on airline flight statistics. Military forces mix with civilian populations from nearby cities.

Level 3. PACOM/Hawaii—The PACOM/Hawaii simulations model the spread and impact of disease on civilian and military populations, including their roles in related support organizations. The state of Hawaii is modeled both at the city and PACOM base level. Alerts and warnings are generated when the operational capabilities of each military base go below configurable thresholds to provide additional insight on the effects of disease spread at this modeling scale. Similar to Level 2, civilians from each city mix with one another based on the distance between the two cities, the total population in each city and travel patterns between cities based on airline flight statistics. Military forces mix with civilian populations from nearby cities.

It should be noted that in the present invention, disease models are stochastic and use probabilities to statistically sample parameters that represent how the disease spread propagates. A consequence of this capability is that outcomes from identically configured simulations will not be exactly the same for each simulation.

Specific interventions—pharmaceutical and non-pharmaceutical—can be applied singularly or in combination in the simulator to assess their possible utility in mitigating the disease and its impact on the population groups that are modeled. The resources or material that are required to support the interventions—stockpiles or equivalent reserves—are modeled and can be applied to specific populations to address the impact of limited resources on specific interventions. For example, stockpiles of pharmaceutical material (vaccines or antimicrobials) are configured in the simulator and used in the intervention model with specified populations or sub-populations. The ability in the present invention to link models of resources to models of disease spread through social and spatial networks is an important capability supporting decision support, analysis and planning.

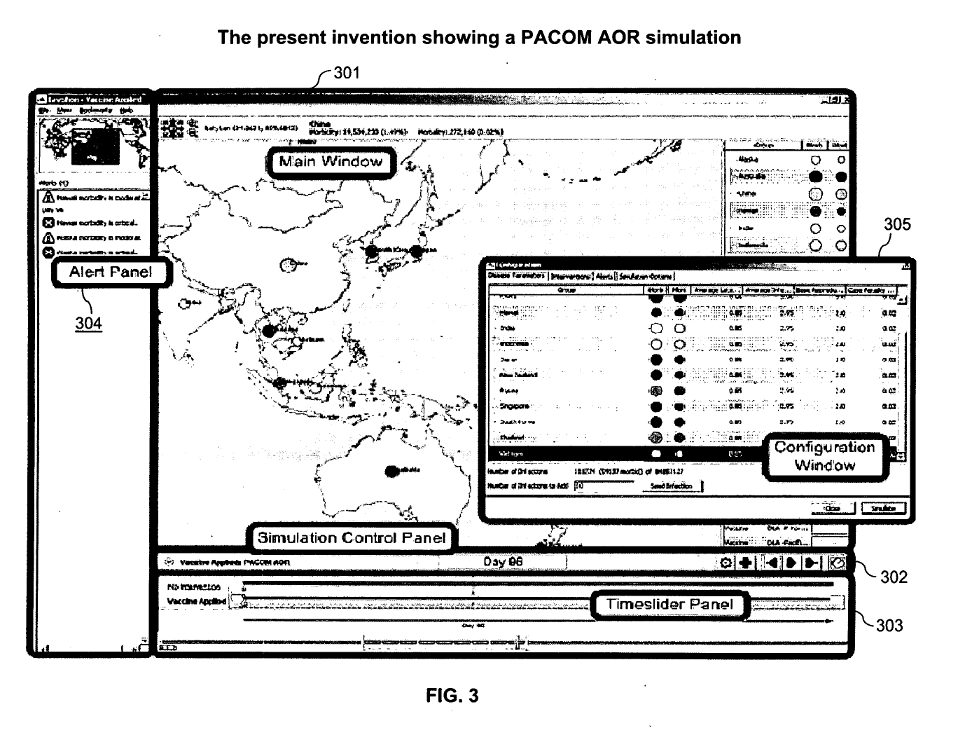

The present invention has several elements which, used together, provide insight into disease effects during and after simulations and allow easy comparison of simulation results. FIG. 3 shows the main simulation windows for Level 1 simulation:

FIG. 3. The Present Invention Showing a PACOM AOR Simulation

The following section describes the most important features of the Main Window for the PACOM AOR simulation shown in FIG. 3.

Main window—The main window 301 shows a map view of morbidity levels at each location. It also displays panels showing detailed information about the status of each population group and subgroup (the group view) and the antiviral/vaccine stockpiles available (the resource view).

Simulation Control panel—The simulation control panel 302 shows the current simulation, simulation time and provides capabilities to control, configure, and replay the selected simulation. Buttons to show and hide the simulation browser are also located on the time slider panel described below.

Time slider panel/simulation browser—The time slider panel 303 shows the current simulation time. The simulation browser facilitates switching between simulations and simulation timepoints.

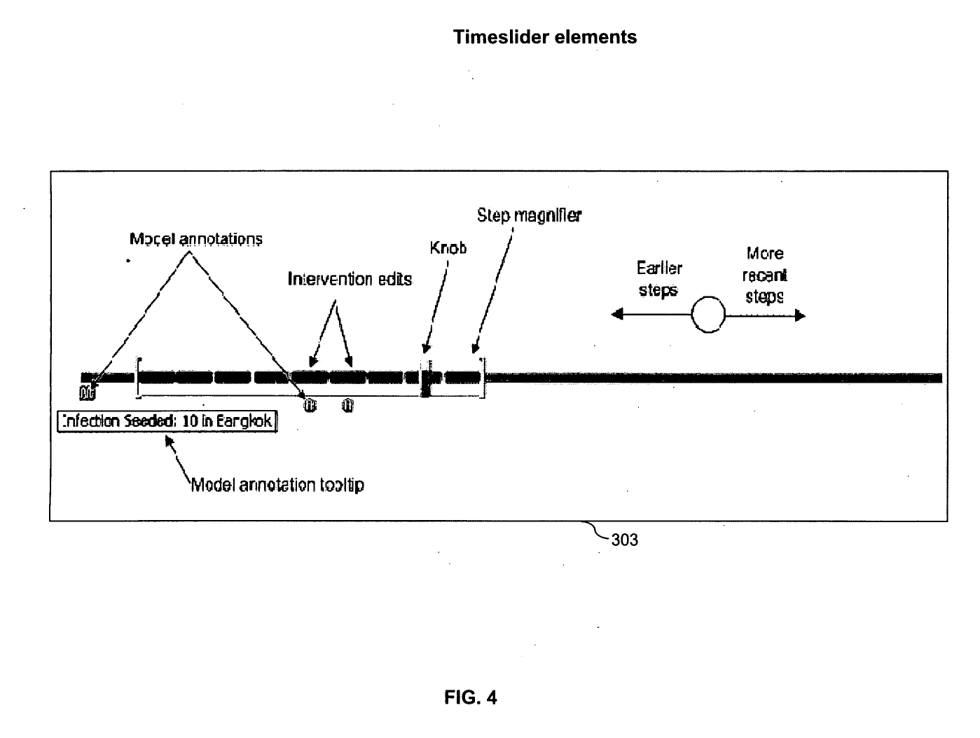

FIG. 4. Time slider elements—The time slider permits moving from time point to time point in a controlled manner to facilitate the understanding of the characteristics of the disease spread for this simulation. In addition, the time slider permits the retrospective application of one or more intervention strategies at an earlier time point during the simulation to facilitate course of action planning.

Alert panel—The alert panel 304 displays messages that can be customized to appear when morbidity levels at a location exceed a user defined threshold, when resource levels fall below a user defined threshold, or for the Level 3 model, when the operational level of a military facility becomes compromised.

Configuration window—Editing the model occurs in the Configuration window 305 shown in FIG. 3. This window permits the user to simulate the seeding of infections, apply and configure interventions, customize alerts based on disease and functional levels, and configure multiple simulations to run. Once the model has been configured, the simulation can be started from this window.

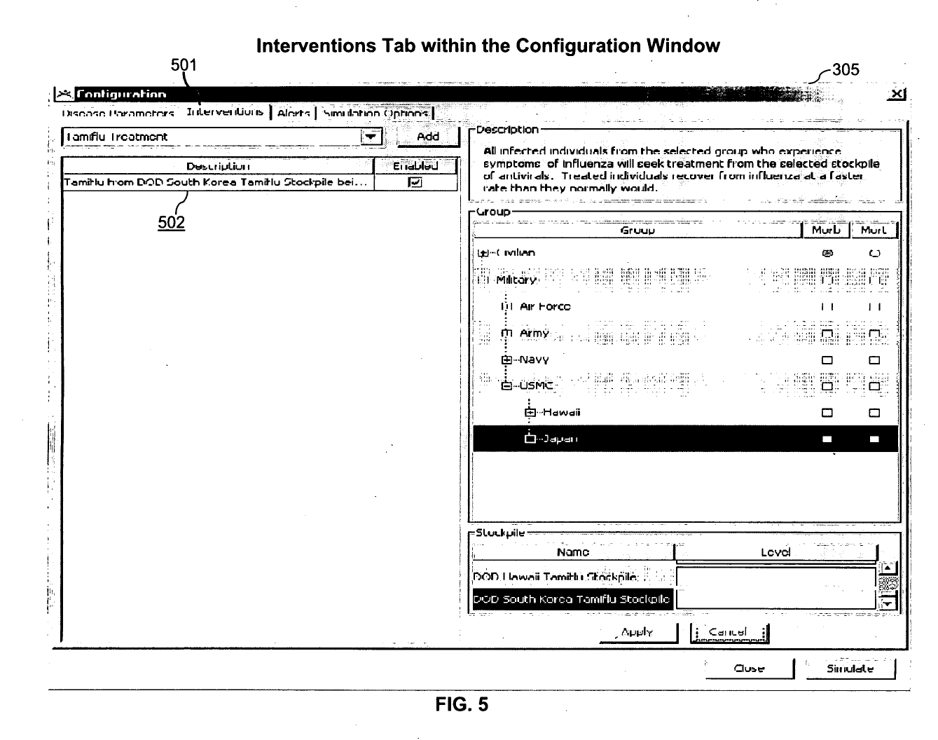

FIG. 5. Interventions Tab within the Configuration Window

In FIG. 5, reference numberal 501 indicates an intervention tab within the Configuration Window. 502 illustrates an example of an intervention that the user can select for simulation.

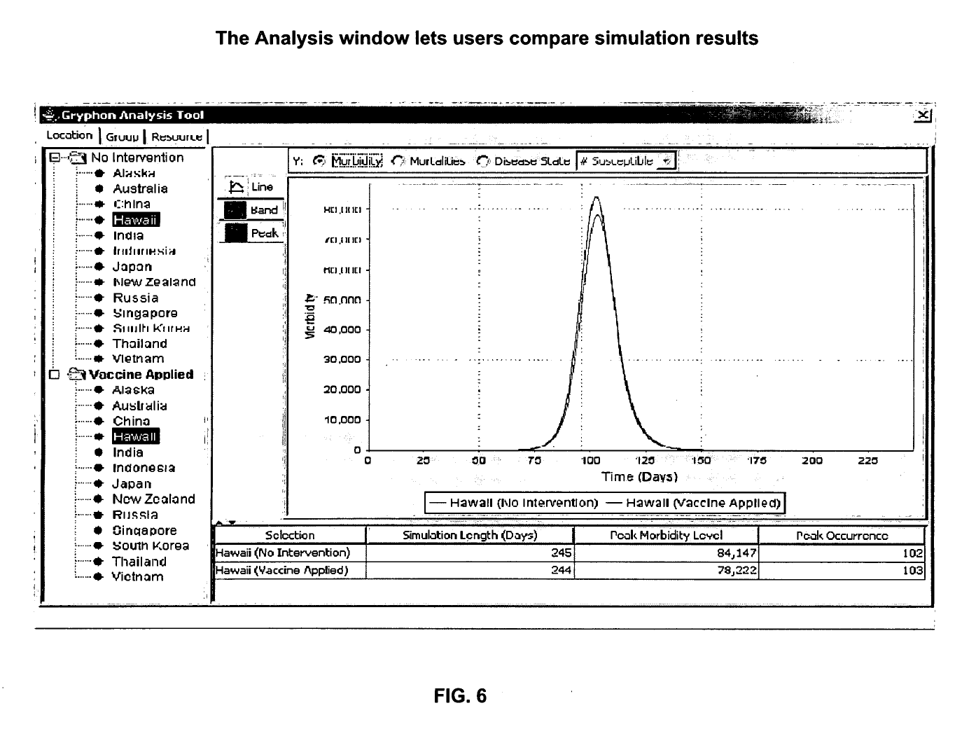

FIG. 6. The Analysis Window Lets Users Compare Simulation Results.

Analysis window—The analysis window, shown in FIG. 6, displays simulation data and analysis results for multiple simulation runs to facilitate a comparison of different intervention strategies on disease statistics and to compare the statistical spread across multiple simulation runs performed under the same parametric conditions.

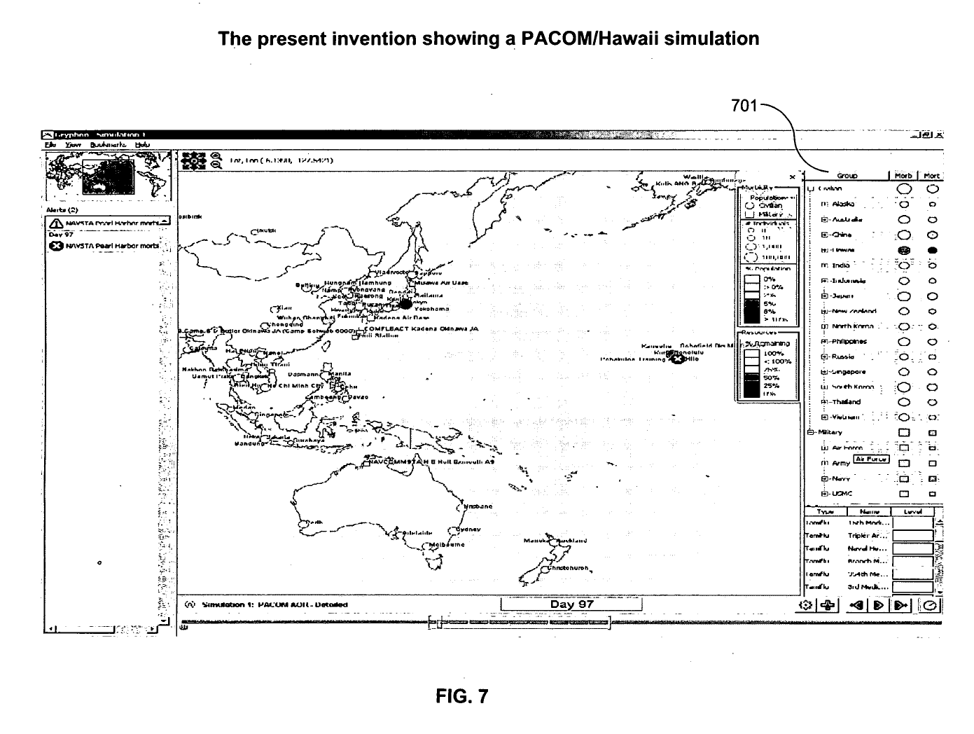

FIG. 7. The Present Invention Showing a PACOM/Hawaii Simulation

FIG. 7 shows the Main Window for Level 2 Simulations that model the more detailed PACOM AOR. Both city location and base locations are shown in the map and the Group Panel 701 on the far right of the Main Window details the structure of both civilian and military groups that define a more differentiated social network than in Level 1 where there is only the civilian social group.

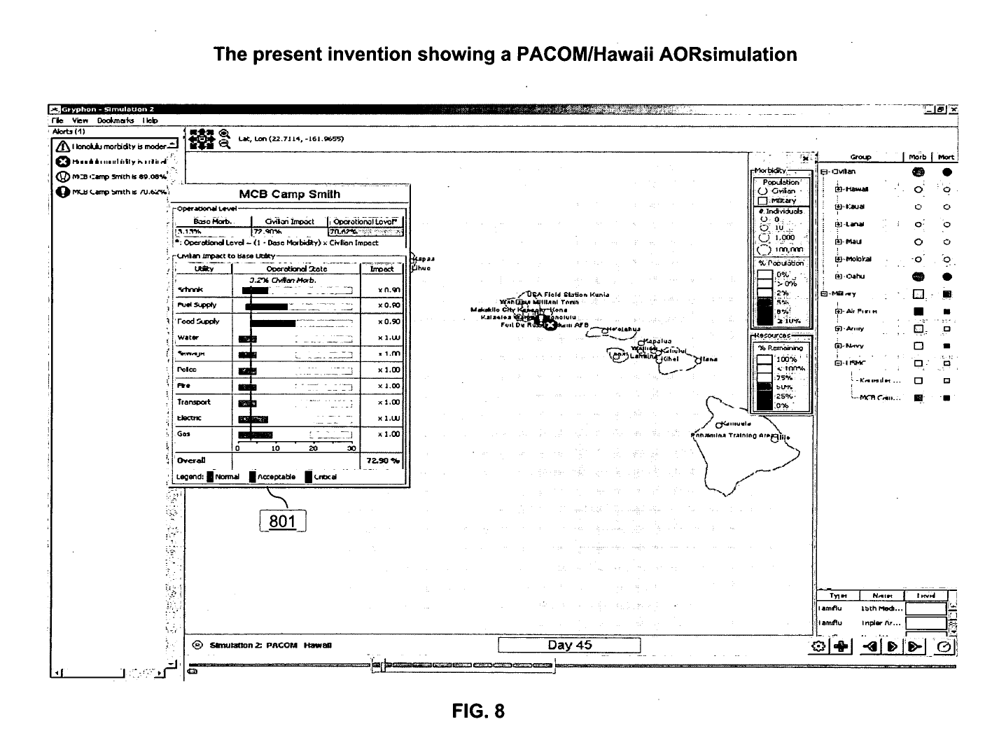

FIG. 8. The present invention showing a PACOM/Hawaii AORsimulation—FIG. 8 shows the Main Window for Level 3 Simulations that model the most detailed PACOM/Hawaii AOR. Both city location and base locations are shown in the map that now only displays Hawaii. The Operational Alerts panel 801 in the center left section of FIG. 8 details the operational level of MCB Camp Smith at the time when an operational alert was triggered. This panel displays the operational status of several critical support capabilities required to maintain normal operations within Camp Smith, demonstrating the capability to model at progressively finer levels of resolution.

### Example 2

### Modeling Disease Spread on Ships—The Shipboard Disease Decision Support Tool (SDDT)

In order to further demonstrate the scalability of the present invention around modeling across wide ranges of both social and spatial networks, a second example centered around the modeling of disease spread on Navy ships is discussed below. This example further demonstrates the capability of the present invention to model across different scales of both spatial and social networks in a flexible fashion, to model disease spread and the impact of pharmaceutical and non-pharmaceutical interventions, suited to decision support, analysis and planning; and to do all of the above in a computationally efficient manner in a PC-based computing environment.

Background—U.S. Navy (USN) missions are critically important to force projection and defense capabilities for the nation and can be compromised by ill health amongst a ship's company. With deployments to geographic locations where endemic disease rates are much higher than in the U.S. and with extended periods of deployment for the USN resources, the potential impact of disease on shipboard operational capability may be significant.

The goal of the Shipboard Disease Decision-Support Tool is to utilize recent advances in computer technology and Agent-based models (ABM) to construct computational models of the effects that shipboard disease and related intervention and treatment procedures have on personnel and their shipboard operational capability. Specific emphasis has been placed on developing a prognostic modeling capability that is focused on Medical Officers (MO) as the end-users.

The SDDT will enable the MO to assess the benefit of specific health interventions or treatments, determine resource requirements for treatment of personnel, and advise their chain of command about the potential impact of the disease on the operational capability of the vessel.

The SDDT will provide decision support capability by modeling the interventions (including combinations of interventions) and providing outputs in the form of prognoses that will enable the MO to determine his/her best course of action. The SDDT will permit multiple rapid tests to be performed using singular or multiple interventions and treatments and thus allow the MO to optimize his/her guidance and actions for effective disease management.

In a network disease model, person to person interactions and their disease status (susceptible, infected, recovered, etc.) become paramount. Network models also facilitate assessment of the relative benefits of different interventions.

In the case of a disease spread aboard the ship, the ‘agents’ in the ABM will include crew (modeled as sub-populations of the ship's company) and locations where the agents interact, and a series of embedded rules for behavior of the ‘agents’ after exposure to the ‘disease’.

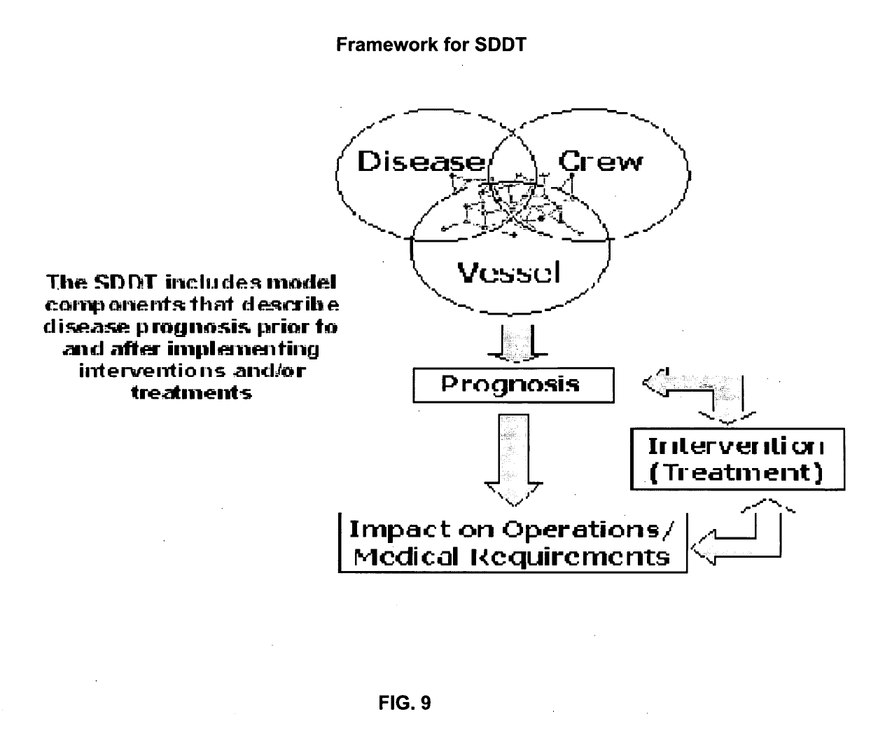

FIG. 9. Framework for SDDT

The advantage of the ABM approach is that the complexity of the system being modeled is realized by the dynamic interaction of the components of the system rather than modeling the complexity explicitly. This results in simpler, modular models that are easier to construct and often more representative of the real system. The agents interact by moving about (or being moved) in a simulated world that represents both the spatial constraints of a ship and the appropriate social constraints. The social constraints capture the roles and behavior of the agents. The two sets of constraints together produce a “social network” that represents the important shipboard activities to be modeled.

Using an ABM approach for the SDDT has enabled the development of a model that has very fast run-time (minutes).

As in the case of the first example, the present invention and example described below can be usefully described as:
Spatial Network—Describes the relationship between locations in the simulation.
Social Network—Describes the relationship between agents at a location.
Disease Model—Model of disease behavior in terms of state transitions, also includes modifications of state transitions based on applying interventions.
Agent-based Simulator—Simulation environment for linkage of components noted above.
Visualization Layer—UI to provide visualization of the simulation.
Analytical and Export Capability—Analytical tools for use with the simulator and capability to export data to external analytical packages.

In this example the components noted above are further detailed as:

| Component | Details |
|---|---|
| Spatial | Defined by the compartments of a Navy ship. Spatial networks are |
| Network | modeled from published shipboard design data |
| Social | Defined by the operational and social interactions of the crew on |
| Network | board a Navy ship. Social networks are modeled from published data |
| | on the statistics of both officers and enlisted crew on board a Navy |
| | ship. Descriptions of their functional duties and typical daily |
| | movement patterns were obtained from crew journals |
| Disease Model | Pandemic Influenza: Disease parameters from published source |
| | (Centers for Disease Control, Atlanta, GA) |
| ABM | MASON: Publicly available from George Mason University, Fairfax, |
| Simulator | VA |
| Visualization | Developed by Quantum Leap Innovations, Inc. Newark, DE from |
| Layer | published ship design data |
| Analytical/ | Developed by Quantum Leap Innovations, Inc. Newark, DE |
| Export | |

Description of System—The SDDT has several elements which, when used together, provide insight into disease effects during and after simulations and allow easy comparison of simulation results. This section will describe the major elements of the SDDT.

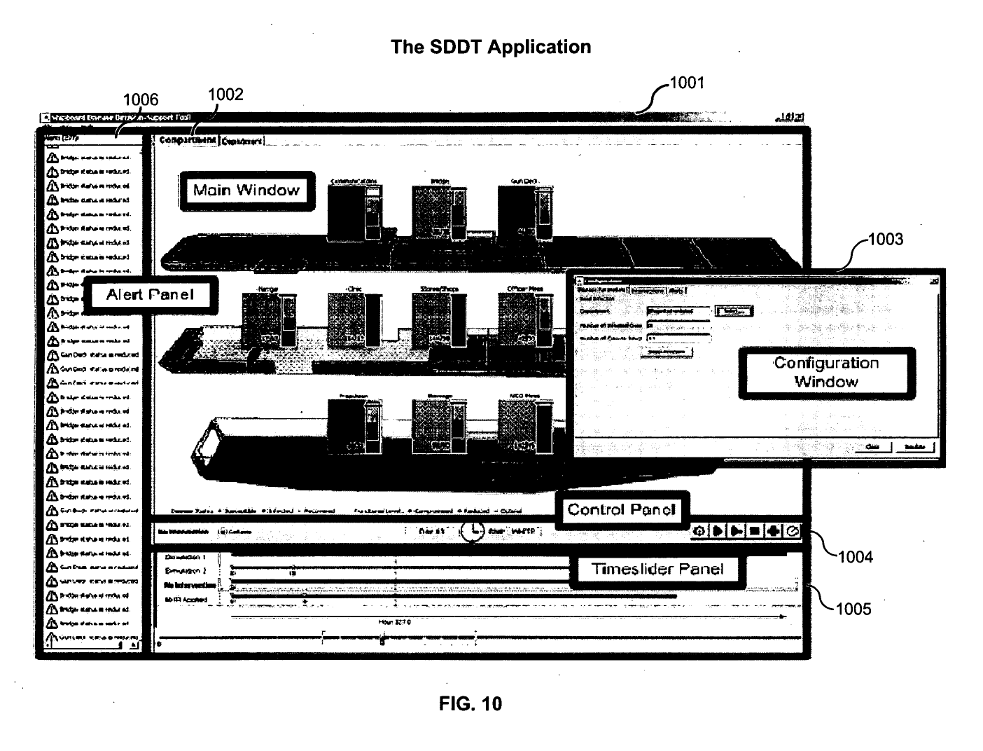

FIG. 10. The SDDT Application

Main window—The main window 1001, shown in FIG. 10 provides two different views, the compartment tab 1002 and the department view. The compartment tab 1002 displays the level of functionality at each station (background color) as well as the number and health of crew members currently at the corresponding station (number and column indicators). The department view shows the health of all shifts and ranks of crew that work at each station, regardless of current location. The department view can be filtered based on both the shift and rank of crew members. One such shift that is referred to in this example is the Red shift that is interleaved with two other shifts that rotate every 72 hours.

Simulation Control panel—The simulation control panel 1004 shows the current simulation, simulation time and the shift that is currently active. It further allows the user to control, configure, and replay the selected simulation.

Time slider panel/simulation browser—The time slider panel shows what the simulation time currently is and the simulation browser makes it easy to switch between simulations and simulation timepoints. Buttons to show and hide the simulation browser are also located on the time slider panel.

Alert panel—The alert panel 1006 shows messages that can be customized to show up when morbidity levels for a compartment get too high or if functionality for a compartment is compromised.

Configuration Window

Editing the simulation (component models) occurs in the Configuration window 1003. It lets the user simulate the start of infections, apply and configure interventions, and customize alerts and notifications based on disease and functional levels. Once the model has been configured, the simulation can be started from within this window.

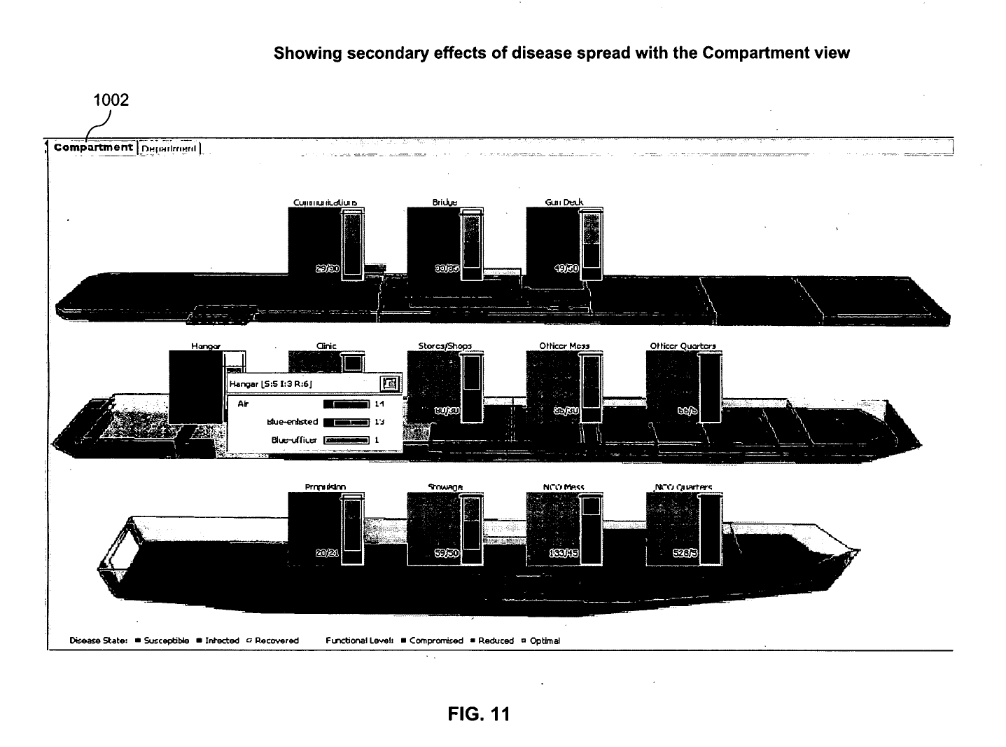

FIG. 11—Showing Secondary Effects of Disease Spread with the Compartment View.

FIG. 11 shows the Compartment tab 1002 during a simulation step while the infection is spreading. Each compartment has a level indicator which indicates the status of personnel in that compartment. The numbers at the bottom of the compartment indicate the number of crew working in the compartment and the number of crew required to fully operate in the compartment. The bar on the level indicator also shows what percentage of crew members, required for that compartment, are present.

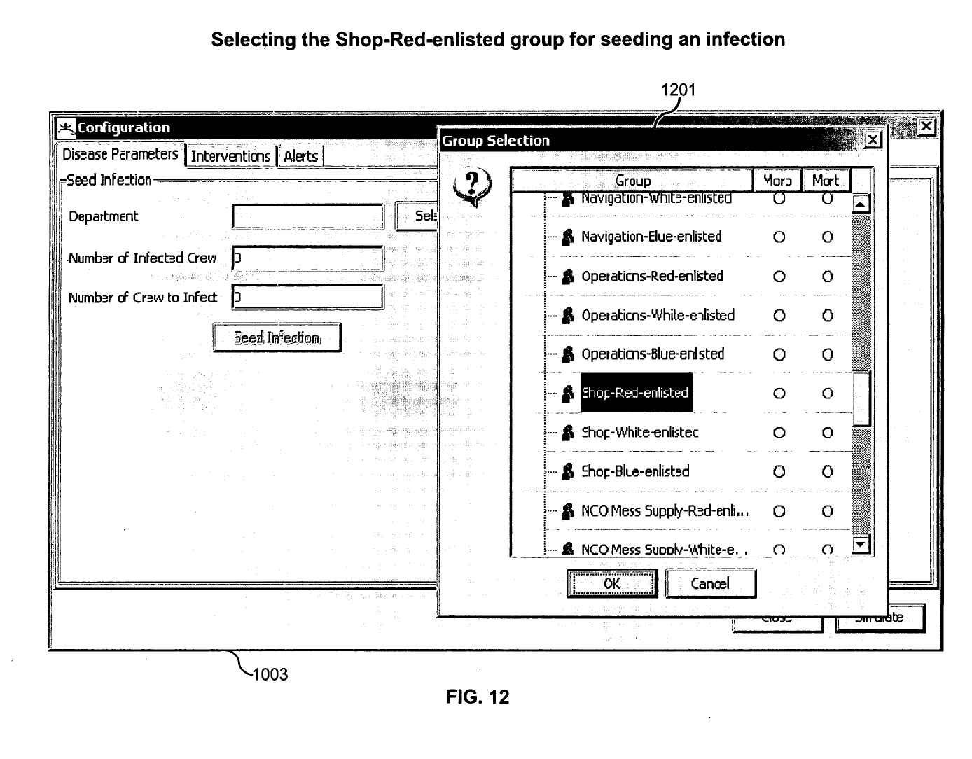

FIG. 12. Selecting the Shop-Red-Enlisted Group for Seeding an Infection.

FIG. 12 shows how an infection can be seeded for a specific group within the ship by the user. The granularity of the groups reflects the detailed operations on board the ship, demonstrating the capability of the present invention to simulate disease spread at multiple scales of resolution.

Analysis window—The analysis window displays infection data for crewmembers and compartments for multiple simulations to help the user compare the effects of applying interventions.

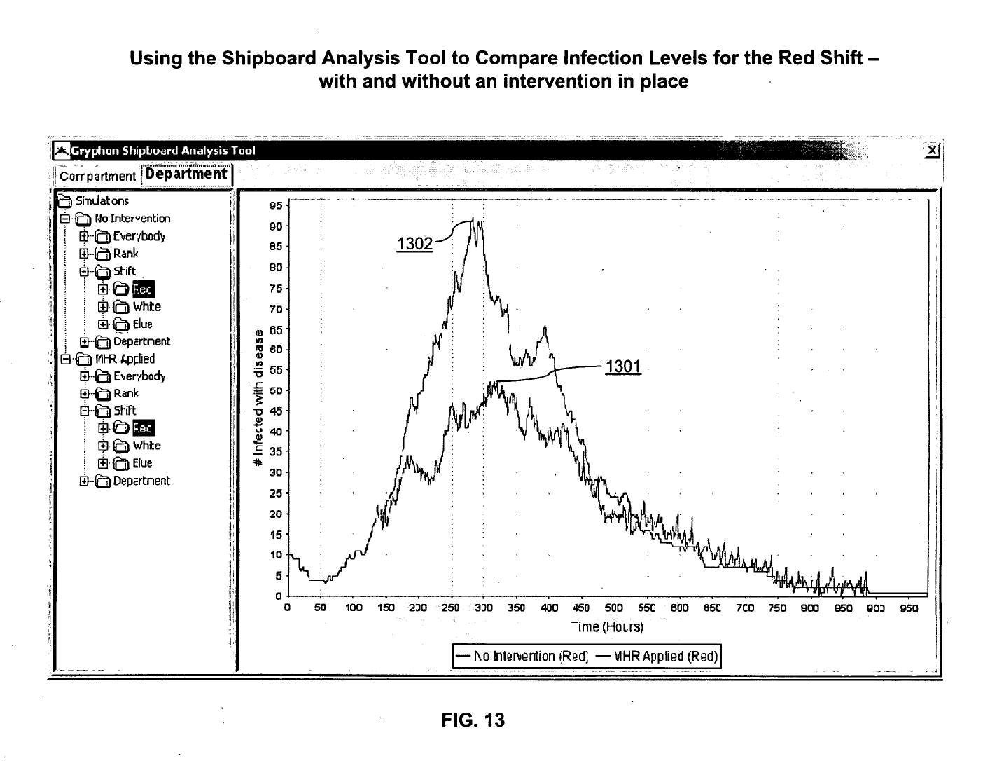

FIG. 13. Using the Shipboard Analysis Tool to Compare Infection Levels for the Red Shift with and without an Intervention in Place

FIG. 13 shows the use of the Analysis tool to compare infection levels for the Red shift with and without a “Mess Hall Redirect” intervention in place. This non-pharmaceutical intervention specifies a percentage of the crew that would normally use the Mess Hall to congregate instead at a different location (in this example, the Helipad). The reduced contact rate between crew can reduce disease spread.

The present invention is further defined by the following claims.

We claim:

1. A method of creating a scalable, computationally efficient and rapid simulation of complex or complex adaptive systems realized through the dynamic interaction of multiple models or modeling components for generating outputs suited to decision support, analysis and planning, comprising:
(a) specifying and modeling a plurality of spatial networks that describe the relationship between a plurality of locations or nodes in a plurality of component models and a multi-model simulation;
(b) specifying and modeling a plurality of social networks that describe at least one relationship between model entities at, or interacting with at least one location or at least one node in the component models and the multi-model simulation;
(c) specifying at least one state based model where entities at a location or node can undergo state transitions that can further be modified based on the dynamic application of interventions that modify state transitions;
(d) using at least one agent based simulator for integrating the individual modeling components where the individual modeling components are designated as agents;
(e) capturing dynamically-updated storage of incremental changes in the simulation in the form of a database or other suitable dataset;
(f) linking the agent based simulation with at least one visualization layer and using the linkage for providing visualization of one or more of the simulations;
(g) providing a user interface for supporting users configuring the simulation and for enabling a simulation to be modified at a specific point for generating a new simulation; and
(h) integrating analytical tools for using the simulator for providing outputs for supporting decision support, subsequent analysis and planning.

2. The method of claim 1 wherein the state based model in step (c) represents a model of disease phenomena among entities in a biological system.

3. The method of claim 1 wherein providing a user interface in step (g) further comprises automatically sampling the statistical distribution of at least one model parameter one or more times for generating a population of one or more simulations.

4. The method of claim 1 wherein providing a user interface in step (g) further comprises:
(a) examining the results of the simulation at least one prior time point in the simulation; and
(b) generating at least one simulation branch from at least one prior time point in the simulation and applying at least one intervention strategy for generating a new simulation.

5. The method of claim 1, further comprising the steps of:
(a) obtaining a specification of appropriate model evaluation for at least one modeling component wherein the specification comprises at least one selected from the group consisting of:
required fidelity, desired fidelity, required detail, desired detail, required consistency, desired consistency, hard processing time limits, soft processing time limits, hard memory limits, and soft memory limits;
(b) applying the specifications for appropriate model evaluation identified in step (a) for customizing the corresponding modeling components to conform to the specifications;
(c) obtaining static or dynamic external data or parameters relating to at least one modeling component within the simulation;
(d) using external data or parameters as empirical evidence relating to at least one modeling component within the simulation;
(e) obtaining or generating a set of potential strategies corresponding to the external data and at least one simulation environment;
(f) using evaluations of the simulation environment, along with the strategies to identify and aid operational planners in choosing the best course of action; and
(g) optionally repeating at least some steps a) through f), as new data or parameters or strategies or evaluation results become available.

6. The method of claim 5, further comprising learning one or more variables or relationships of the representation parameters of at least one modeling component from the empirical evidence.

7. The method of claim 5, further comprising learning at least one correspondence between a plurality of modeling components from the empirical evidence.

8. The method of claim 5, further comprising:
(a) obtaining a first set of potential strategies by learning relationships between potential actions and likely outcomes; and
(b) optionally obtaining a second refined set of potential strategies by offering the first set of potential strategies to a generalized actor for review.

9. The method of claim 1, further comprising the steps of:
(a) creating a representation of at least one model entity or group in a social network comprising at least one member;
(b) creating a representation of at least one location in a spatial network;
(c) creating a representation of at least one state in which members of the groups may be in;
(d) creating representations of the number of members of each of the groups which are in each of their possible states;
(e) creating representations of indications that the members of the groups will be at different locations at given times; and
(f) calculating the number of members of each of the groups that are in each of the states for a given time.

10. The method of claim 2 wherein the model of disease phenomena among entities in a biological system is based on ordinary differential equations.

11. The method of claim 1 further comprising extending the specification and modeling of spatial networks in step (a) over a wide range of spatial scales wherein the spatial scales comprise at least one selected from the group consisting of:
Geographical site (Country, City, military base), Facility or room or rooms within a facility where a facility could include a hospital, base or factory, Compartments or other defined area on a vessel, ship, vehicle or aircraft, population of individuals, organ, or population of cells within a biological system.

12. A hybrid simulation engine for modeling disease spread comprising a computer system, having one or more processors or virtual machines, each processor comprising at least one core, the system comprising one or more memory units, one or more input devices and one or more output devices, optionally a network, and optionally shared memory supporting communication among the processors for rapid simulation of complex or complex adaptive systems realized through the dynamic interaction of multiple models or modeling components for generating outputs suited to decision support, analysis and planning comprising:
(a) means for specifying and modeling a plurality of spatial networks that describe the relationship between a plurality of locations or nodes in a plurality of component models and a multi-model simulation;
(b) means for specifying and modeling a plurality of social networks that describe at least one relationship between model entities at, or interacting with at least one location or at least one node in the component models and the multi-model simulation;
(c) means for specifying at least one state based model where entities at a location or node can undergo state transitions that can further be modified based on the dynamic application of interventions that modify state transitions;
(d) means for using at least one agent based simulator for integrating the individual modeling components wherein the individual modeling components are designed as agents;
(e) means for capturing dynamically-updated storage of incremental changes in the simulation in the form of a database or other suitable dataset;
(f) means for linking the agent based simulation with at least one visualization layer and using the linkage for providing visualization of one or more of the simulations;
(g) means for providing a user interface for supporting users configuring the simulation and for enabling a simulation to be modified at a specific point for generating a new simulation; and
(h) means for integrating analytical tools for using the simulator for providing outputs for supporting decision support, subsequent analysis and planning.
